(19) United States
(12) Patent Application Publication
(10) Pub. No.: US 2017/0083573 A1
(43) Pub. Date: Mar. 23, 2017

(54) MULTI-QUERY OPTIMIZATION

(71) Applicant: ALGEBRAIX DATA CORP., Austin, TX (US)

(72) Inventors: William Arthur ROGERS, Austin, TX (US); Joseph C. UNDERBRINK, Round Rock, TX (US); Jason Tyler MCDANIEL, Austin, TX (US); Srdan ZIROJEVIC, Austin, TX (US); Wesley A. HOLLER, Round Rock, TX (US)

(21) Appl. No.: 15/222,229

(22) Filed: Jul. 28, 2016

Related U.S. Application Data
(60) Provisional application No. 62/198,242, filed on Jul. 29, 2015.

(51) Int. Cl. G06F 17/30

(52) U.S. Cl. CPC G06F 17/30448; G06F 17/30477; G06F 17/30958

(57) ABSTRACT

Systems and methods allow the use of algebra to optimize several queries at once by algebraically breaking them into pieces, interleaving them in the most efficient way and then computing the queries together. For instance, a user or application may have many queries to process. A computing device may handle each query sequentially. However, if the computing device handled the queries simultaneously and if they are presented at once, there are ways to algebraically optimize them together by interleaving the tasks required to execute each one and complete the entire batch more efficiently.

### RELATED APPLICATIONS

This application claims the benefit of priority to U.S. Provisional Application No. 62/198,242 entitled “Multi-Query Optimization” filed Jul. 29, 2015, the entire contents of which are hereby incorporated by reference.

### SUMMARY

Systems and methods allow the use of algebra to optimize several queries at once by algebraically breaking them into pieces, interleaving them in the most efficient way and then computing the queries together. For instance, a user or application may have many queries to process. A computing device may handle each query sequentially. However, if the computing device handled the queries simultaneously and if they are presented at once, there are ways to algebraically optimize them together by interleaving the tasks required to execute each one and complete the entire batch more efficiently.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a block diagram showing an example architecture of a computer system that may be suitable for use with the various embodiments.

FIG. 2 is a block diagram showing a computer network that may be suitable for use with the various embodiments.

FIG. 3 is a block diagram showing an example architecture of a computer system that may be suitable for use with the various embodiments.

FIG. 4A is a block diagram illustrating the logical architecture according to the various embodiments.

FIG. 4B is a block diagram illustrating the information stored in an algebraic cache according to various embodiments.

FIG. 5 illustrates an example of a mathematical expression for a database query according to various embodiments.

FIG. 6 illustrates an example of a graphical representation of a mathematical expression for a database query according to various embodiments.

FIG. 7 illustrates query graphs of single queries according to various embodiments.

FIG. 8 illustrates a combined query graph for multiple queries according to various embodiments.

FIG. 9 illustrates a combined query graph for multiple queries reusing a common sub-expression according to various embodiments.

FIG. 10 illustrates a method for multi-query optimization according to various embodiments.

FIG. 11 is a component diagram of an example computing device suitable for use with the various embodiments.

FIG. 12 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “computing device” is used to refer to any one or all of servers, desktop computers, personal data assistants (PDA's), laptop computers, tablet computers, smart books, palm-top computers, smart phones, and similar electronic devices which include a programmable processor and memory and circuitry configured to provide the functionality described herein.

The various embodiments are described herein using the term “server.” The term “server” is used to refer to any computing device capable of functioning as a server, such as a master exchange server, web server, mail server, document server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as a laptop computer, thereby enabling it to function as a server (e.g., an enterprise e-mail server) only to the extent necessary to provide the functionality described herein.

The various embodiments provide systems and methods for data storage and processing and algebraic optimization. In one example, a universal data model based on data algebra may be used to capture scalar, structural and temporal information from data provided in a wide variety of disparate formats. For example, data in fixed format, comma separated value (CSV) format, Extensible Markup Language (XML) and other formats may be captured and efficiently processed without loss of information. These encodings are referred to as physical formats. The same logical data may be stored in any number of different physical formats. Example embodiments may seamlessly translate between these formats while preserving the same logical data.

By using a rigorous mathematical data model, example embodiments can maintain algebraic integrity of data and their interrelationships, provide temporal invariance and enable adaptive data restructuring.

Algebraic integrity enables manipulation of algebraic relations to be substituted for manipulation of the information it models. For example, a query may be processed by evaluating algebraic expressions at processor speeds rather than requiring various data sets to be retrieved and inspected from storage at much slower speeds.

Temporal invariance may be provided by maintaining a constant value, structure and location of information until it is discarded from the system. Standard database operations such as “insert,” “update” and “delete” functions create new data defined as algebraic expressions which may, in part, contain references to data already identified in the system. Since such operations do not alter the original data, example embodiments provide the ability to examine the information contained in the system as it existed at any time in its recorded history.

Adaptive data restructuring in combination with algebraic integrity allows the logical and physical structures of information to be altered while maintaining rigorous mathematical mappings between the logical and physical structures. Adaptive data restructuring may be used in example embodiments to accelerate query processing and to minimize data transfers between persistent storage and volatile storage.

Example embodiments may use these features to provide dramatic efficiencies in accessing, integrating and processing dynamically-changing data, whether provided in XML, relational or other data formats.

The mathematical data model allows example embodiments to be used in a wide variety of computer architectures and systems and naturally lends itself to massively-parallel computing and storage systems. Some example computer architectures and systems that may be used in connection with example embodiments will now be described.

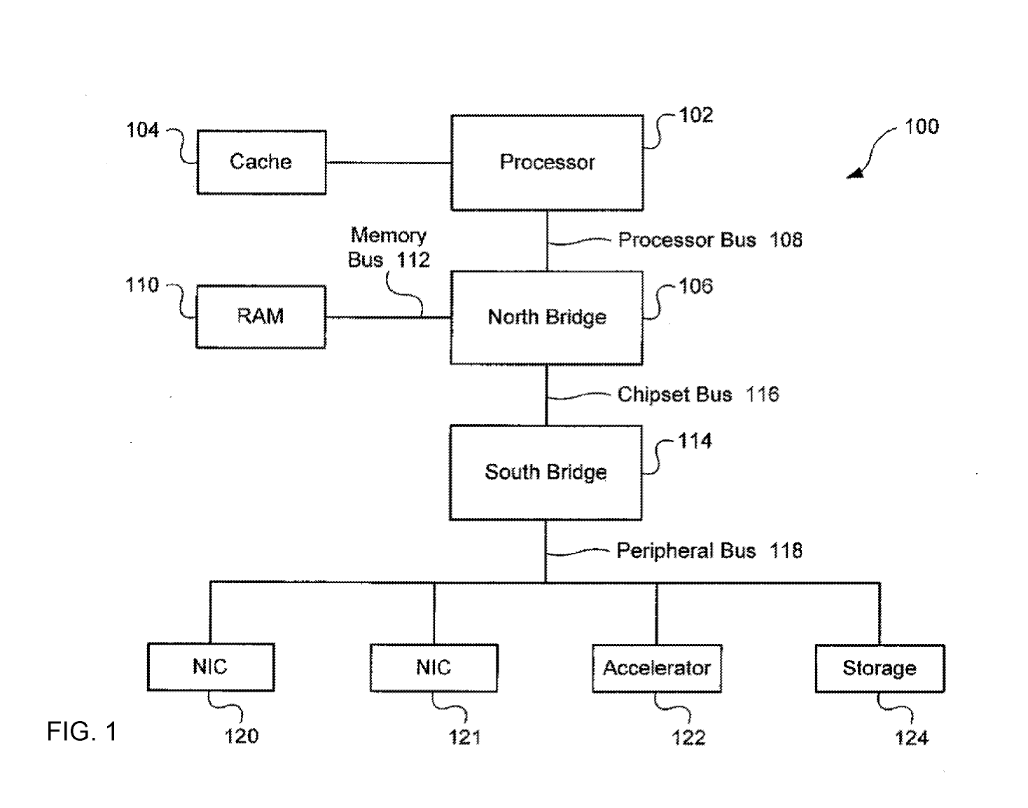

FIG. 1 is a block diagram showing a first example architecture of a computer system 100 that may be used in connection the various embodiments. As shown in FIG. 1, the example computer system may include a processor 102 for processing instructions, such as an Intel Xeon™ processor, AMD Opteron™ processor or other processor. Multiple threads of execution may be used for parallel processing. In some embodiments, multiple processors or processors with multiple cores may also be used, whether in a single computer system, in a cluster or distributed across systems over a network.

As shown in FIG. 1, a high speed cache 104 may be connected to, or incorporated in, the processor 102 to provide a high speed memory for instructions or data that have been recently, or are frequently, used by processor 102. The processor 102 is connected to a north bridge 106 by a processor bus 108. The north bridge 106 is connected to random access memory (RAM) 110 by a memory bus 112 and manages access to the RAM 110 by the processor 102. The north bridge 106 is also connected to a south bridge 114 by a chipset bus 116. The south bridge 114 is, in turn, connected to a peripheral bus 118. The peripheral bus may be, for example, PCI, PCI-X, PCI Express or other peripheral bus. The north bridge and south bridge are often referred to as a processor chipset and manage data transfer between the processor, RAM and peripheral components on the peripheral bus 118. In some alternative architectures, the functionality of the north bridge may be incorporated into the processor instead of using a separate north bridge chip.

In some embodiments, system 100 may include an accelerator card 122 attached to the peripheral bus 118. The accelerator may include field programmable gate arrays (FPGAs), graphics processing units (GPUs), or other hardware for accelerating certain processing. For example, an accelerator may be used for adaptive data restructuring or to evaluate algebraic expressions used in extended set processing.

Software and data are stored in external storage 124 and may be loaded into RAM 110 and/or cache 104 for use by the processor. The system 100 includes an operating system for managing system resources, such as Linux or other operating system, as well as application software running on top of the operating system for managing data storage and optimization in accordance with the various embodiments.

In this example, system 100 also includes network interface cards (NICs) 120 and 121 connected to the peripheral bus for providing network interfaces to external storage such as Network Attached Storage (NAS) and other computer systems that can be used for distributed parallel processing.

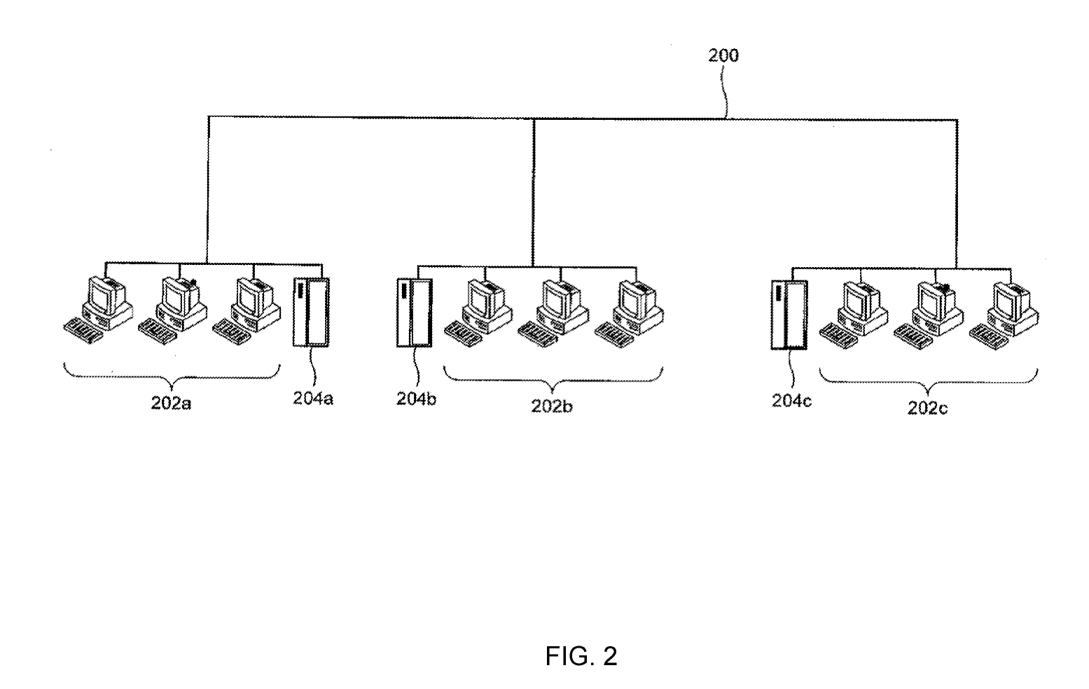

FIG. 2 is a block diagram showing a network 200 with a plurality of computer systems 202a, b and c and Network Attached Storage (NAS) 204a, b and c. In example embodiments, computer systems 202a, b and c may manage data storage and optimize data access for data stored in Network Attached Storage (NAS) 204a, b and c. A mathematical model may be used for the data and be evaluated using distributed parallel processing across computer systems 202a, b and c. Computer systems 202a, b and c may also provide parallel processing for adaptive data restructuring of the data stored in Network Attached Storage (NAS) 204a, b and c. This is an example only and a wide variety of other computer architectures and systems may be used. For example, a blade server may be used to provide parallel processing. Processor blades may be connected through a back plane to provide parallel processing. Storage may also be connected to the back plane or as Network Attached Storage (NAS) through a separate network interface.

In example embodiments, processors may maintain separate memory spaces and transmit data through network interfaces, back plane or other connectors for parallel processing by other processors. In other embodiments, some or all of the processors may use a shared virtual address memory space.

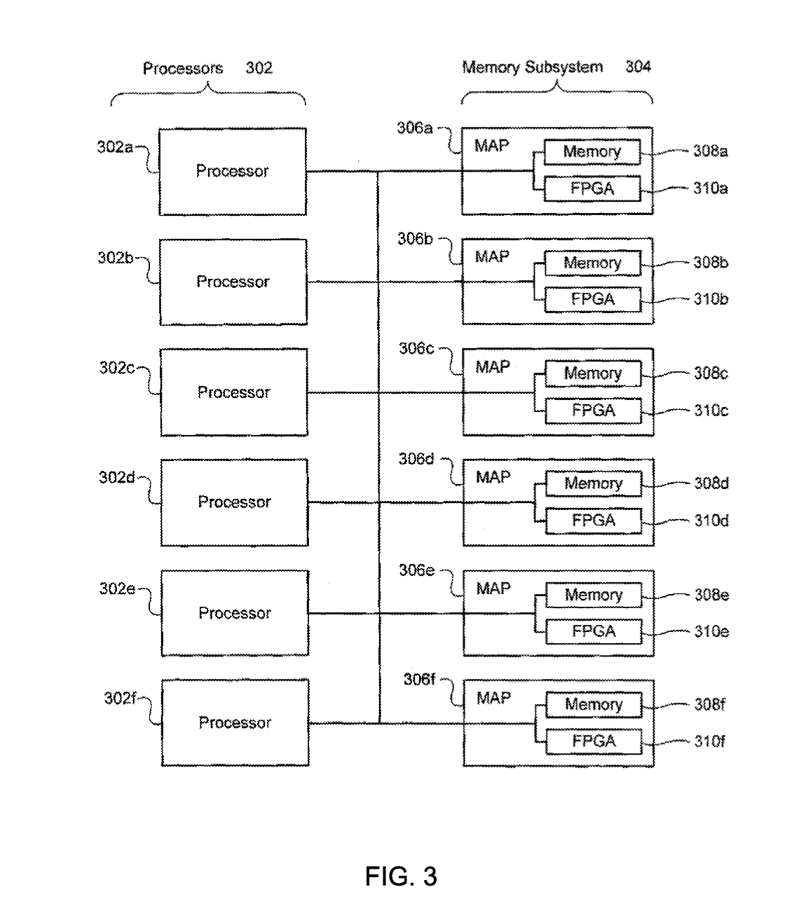

FIG. 3 is a block diagram of a multiprocessor computer system 300 using a shared virtual address memory space in accordance with an example embodiment. The system includes a plurality of processors 302a-f that may access a shared memory subsystem 304. The system incorporates a plurality of programmable hardware memory algorithm processors (MAPs) 306a-f in the memory subsystem 304. Each MAP 306a-f may comprise a memory 308a-f and one or more field programmable gate arrays (FPGAs) 310a-f. The MAP provides a configurable functional unit and particular algorithms or portions of algorithms may be provided to the FPGAs 310a-f for processing in close coordination with a respective processor. For example, the MAPs may be used to evaluate algebraic expressions regarding the data model and to perform adaptive data restructuring in example embodiments. In this example, each MAP is globally accessible by all of the processors for these purposes. In one configuration, each MAP can use Direct Memory Access (DMA) to access an associated memory 308a-f, allowing it to execute tasks independently of, and asynchronously from, the respective microprocessor 302a-f. In this configuration, a MAP may feed results directly to another MAP for pipelining and parallel execution of algorithms.

The above computer architectures and systems are examples only and a wide variety of other computer architectures and systems can be used in connection with example embodiments, including systems using any combination of general processors, co-processors, FPGAs and other programmable logic devices, system on chips (SOCs), application specific integrated circuits (ASICs) and other processing and logic elements. It is understood that all or part of the data management and optimization system may be implemented in software or hardware and that any variety of data storage media may be used in connection with example embodiments, including random access memory, hard drives, flash memory, tape drives, disk arrays, Network Attached Storage (NAS) and other local or distributed data storage devices and systems.

In example embodiments, the data management and optimization system may be implemented using software modules executing on any of the above or other computer architectures and systems. In other embodiments, the functions of the system may be implemented partially or completely in firmware, programmable logic devices such as field programmable gate arrays (FPGAs) as referenced in FIG. 3, system on chips (SOCs), application specific integrated circuits (ASICs), or other processing and logic elements. For example, the Set Processor and Optimizer may be implemented with hardware acceleration through the use of a hardware accelerator card, such as accelerator card 122 illustrated in FIG. 1.

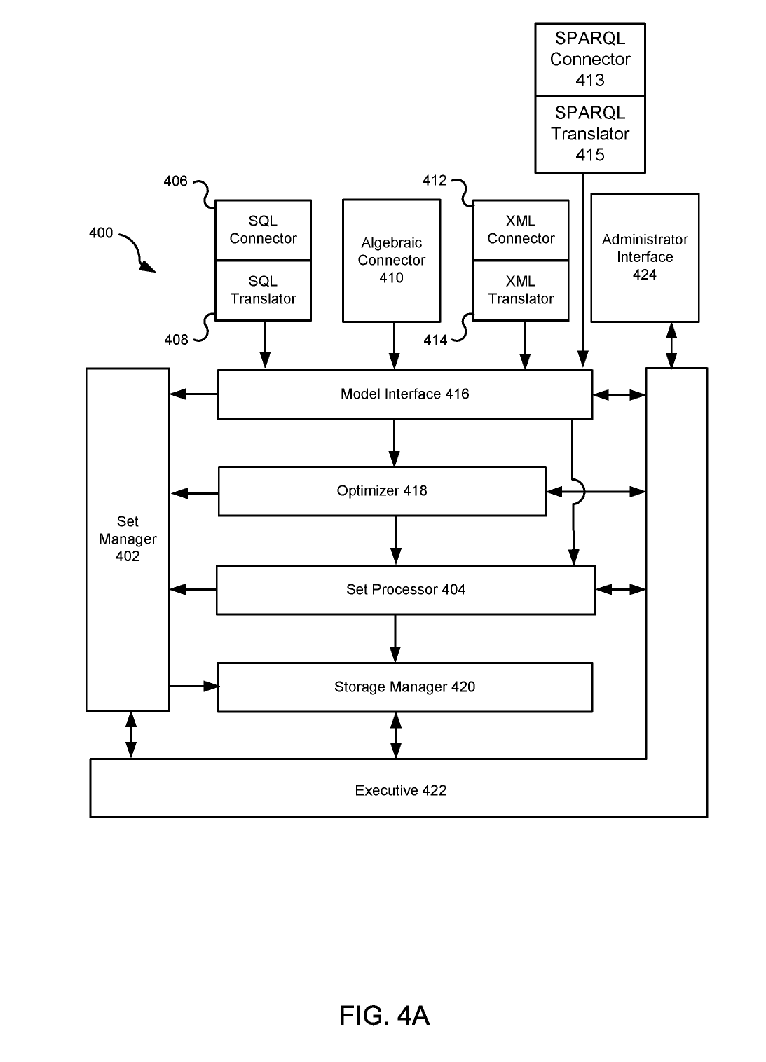

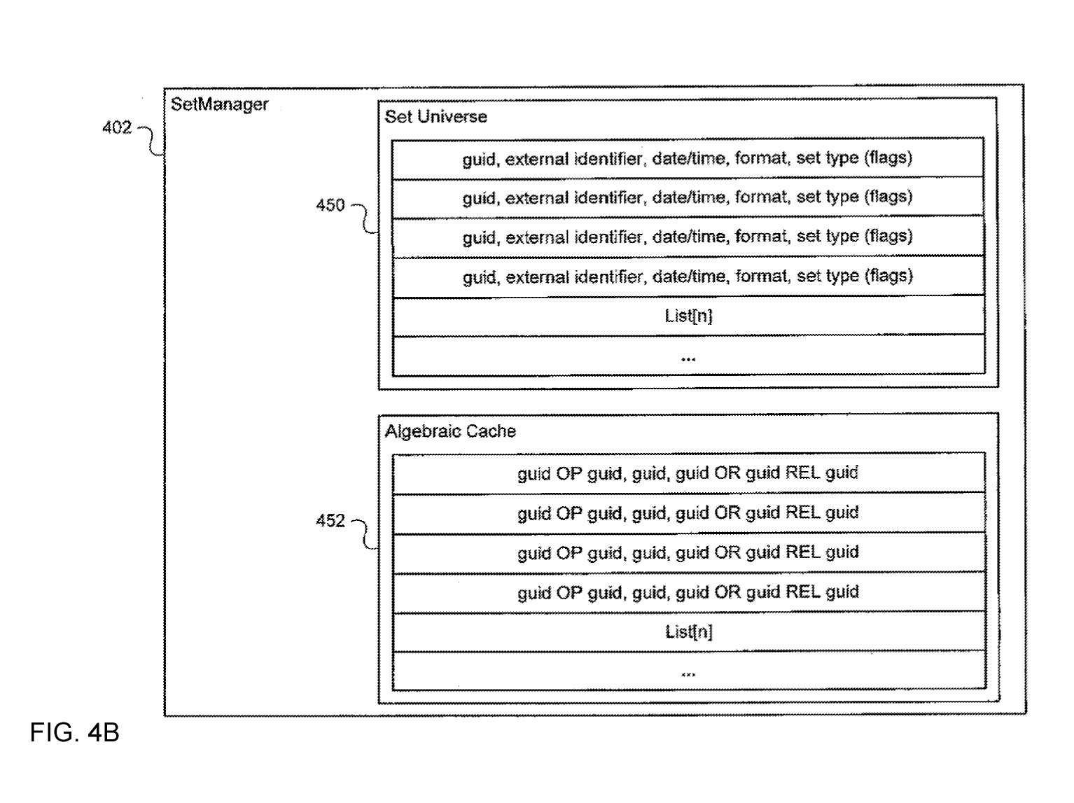

FIG. 4A is a block diagram illustrating the logical architecture of example software modules 400. The software is component-based and organized into modules that encapsulate specific functionality as shown in FIG. 4A. This is an example only and other software architectures may be used as well.

In this example embodiment, data natively stored in one or more various physical formats may be presented to the system. The system creates a mathematical representation of the data based on extended set theory and may assign the mathematical representation a Globally Unique Identifier (GUID) for unique identification within the system. In this example embodiment, data is internally represented in the form of algebraic expressions applied to one or more data sets, where the data may or may not be defined at the time the algebraic expression is created. The data sets include sets of data elements, referred to as members of the data set. In an example embodiment, the elements may be data values or algebraic expressions formed from combinations of operators, values and/or other data sets. In this example, the data sets are the operands of the algebraic expressions. The algebraic relations defining the relationships between various data sets are stored and managed by a Set Manager 402 software module. Algebraic integrity is maintained in this embodiment, because all of the data sets are related through specific algebraic relations. A particular data set may or may not be stored in the system. Some data sets may be defined solely by algebraic relations with other data sets and may need to be calculated in order to retrieve the data set from the system. Some data sets may even be defined by algebraic relations referencing data sets that have not yet been provided to the system and cannot be calculated until those data sets are provided at some future time.

In an example embodiment, the algebraic relations and GUIDs for the data sets referenced in those algebraic relations are not altered once they have been created and stored in the Set Manager 402. This provides temporal invariance which enables data to be managed without concerns for locking or other concurrency-management devices and related overheads. Algebraic relations and the GUIDs for the corresponding data sets are only appended in the Set Manager 402 and not removed or modified as a result of new operations. This results in an ever-expanding universe of operands and algebraic relations, and the state of information at any time in its recorded history may be reproduced. In this embodiment, a separate external identifier may be used to refer to the same logical data as it changes over time, but a unique GUID is used to reference each instance of the data set as it exists at a particular time. The Set Manager 402 may associate the GUID with the external identifier and a time stamp to indicate the time at which the GUID was added to the system. The Set Manager 402 may also associate the GUID with other information regarding the particular data set. This information may be stored in a list, table or other data structure in the Set Manager 402 (referred to as the Set Universe in this example embodiment). The algebraic relations between data sets may also be stored in a list, table or other data structure in the Set Manager 402 (for example, an Algebraic Cache 452 within the Set Manager 402 in this example embodiment).

In some embodiments, Set Manager 402 can be purged of unnecessary or redundant information, and can be temporally redefined to limit the time range of its recorded history. For example, unnecessary or redundant information may be automatically purged and temporal information may be periodically collapsed based on user settings or commands. This may be accomplished by removing all GUIDs from the Set Manager 402 that have a time stamp before a specified time. All algebraic relations referencing those GUIDs are also removed from the Set Manager 402. If other data sets are defined by algebraic relations referencing those GUIDs, those data sets may need to be calculated and stored before the algebraic relation is removed from the Set Manager 402.

In one example embodiment, data sets may be purged from storage and the system can rely on algebraic relations to recreate the data set at a later time if necessary. This process is called virtualization. Once the actual data set is purged, the storage related to such data set can be freed but the system maintains the ability to identify the data set based on the algebraic relations that are stored in the system. In one example embodiment, data sets that are either large or are referenced less than a certain threshold number of times may be automatically virtualized. Other embodiments may use other criteria for virtualization, including virtualizing data sets that have had little or no recent use, virtualizing data sets to free up faster memory or storage or virtualizing data sets to enhance security (since it is more difficult to access the data set after it has been virtualized without also having access to the algebraic relations). These settings could be user-configurable or system-configurable. For example, if the Set Manager 402 contained a data set A as well as the algebraic relation that A equals the intersection of data sets B and C, then the system could be configured to purge data set A from the Set Manager 402 and rely on data sets B and C and the algebraic relation to identify data set A when necessary. In another example embodiment, if two or more data sets are equal to one another, all but one of the data sets could be deleted from the Set Manager 402. This may happen if multiple sets are logically equal but are in different physical formats. In such a case, all but one of the data sets could be removed to conserve physical storage space.

When the value of a data set needs to be calculated or provided by the system, an Optimizer 418 may retrieve algebraic relations from the Set Manager 402 that define the data set. The Optimizer 418 can also generate additional equivalent algebraic relations defining the data set using algebraic relations from the Set Manager 402. Then the most efficient algebraic relation can then be selected for calculating the data set.

A Set Processor 404 software module provides an engine for performing the arithmetic and logical operations and functions required to calculate the values of the data sets represented by algebraic expressions and to evaluate the algebraic relations. The Set Processor 404 also enables adaptive data restructuring. As data sets are manipulated by the operations and functions of the Set Processor 404, they are physically and logically processed to expedite subsequent operations and functions. The operations and functions of the Set Processor 404 are implemented as software routines in one example embodiment. However, such operations and functions could also be implemented partially or completely in firmware, programmable logic devices such as field programmable gate arrays (FPGAs) as referenced in FIG. 3, system on chips (SOCs), application specific integrated circuits (ASICs), or other hardware or a combination thereof. Alternatively, the operations and functions of the Set Processor 404 may be implemented as a separate service external to the algebraic optimization system, such as third party software and/or hardware. For example, a third party server may host applications for performing the operations and functions of the Set Processor 404, and the third party server and the algebraic optimization system may communicate over a communications network, such as the Internet.

The software modules shown in FIG. 4A will now be described in further detail. As shown in FIG. 4A, the software includes Set Manager 402 and Set Processor 404 as well as SQL Connector 406, SQL Translator 408, Algebraic Connector 410, XML Connector 412, XML Translator 414, SPARQL Connector 413, SPARQL Translator 415, Model Interface 416, Optimizer 418, Storage Manager 420, Executive 422 and Administrator Interface 424.

In the example embodiment of FIG. 4A, queries and other statements about data sets are provided through one of connectors, SQL Connector 406, Algebraic Connector 410, XML Connector 412, and/or SPARQL connector 413. Each connector receives and provides statements in a particular format, and various connector standards and formats known or used in the art may be used by the various connectors illustrated in FIG. 4A. In one example, SQL Connector 406 provides a standard SQL92-compliant ODBC connector to user applications and ODBC-compliant third-party relational database systems, and XML Connector 412 provides a standard Web Services W3C XQuery-compliant connector to user applications, compliant third-party XML systems, and other instances of the software 400 on the same or other systems. SQL and XQuery are example formats for providing query language statements to the system, but other formats may also be used. Query language statements provided in these formats are translated by SQL Translator 408 and XML Translator 414 into an algebraic format that is used by the system. Algebraic Connector 410 provides a connector for receiving statements directly in an algebraic format. The SPARQL Connector 413 provides a SPARQL compliant connector to applications and other database systems. Query language statements provided in SPARQL may be translated by the SPARQL Translator 415 and provided to the Model Interface 416. Other embodiments may also use different types and formats of data sets and algebraic relations to capture information from statements provided to the system.

Model Interface 416 provides a single point of entry for all statements from the connectors. The statements are provided from SQL Translator 408, XML Translator 414, SPARQL Translator 415, or Algebraic Connector 410 in an XSN format. The Model Interface 416 provides a parser that converts the text description into an internal representation that is used by the system. In one example, the internal representation uses a graph data structure, as described further below. As the statements are parsed, the Model Interface 416 may call the Set Manager 402 to assign GUIDs to the data sets referenced in the statements. The overall algebraic relation representing the statement may also be parsed into components that are themselves algebraic relations. In an example embodiment, these components may be algebraic relations with an expression composed of a single operation that reference from one to three data sets. Each algebraic relation may be stored in the Algebraic Cache (e.g., Algebraic Cache 452) in the Set Manager 402. A GUID may be added to the Set Universe for each new algebraic expression, representing a data set defined by the algebraic expression. The Model Interface 416 thereby composes a plurality of algebraic relations referencing the data sets specified in statements presented to the system as well as new data sets that may be created as the statements are parsed. In this manner, the Model Interface 416 and Set Manager 402 capture information from the statements presented to the system. These data sets and algebraic relations can then be used for algebraic optimization when data sets need to be calculated by the system.

The Set Manager 402 provides a data set information store for storing information regarding the data sets known to the system, referred to as the Set Universe in this example. The Set Manager 402 also provides a relation store for storing the relationships between the data sets known to the system, referred to as the Algebraic Cache (e.g., Algebraic Cache 452) in this example. FIG. 4B illustrates the information maintained in the Set Universe 450 and Algebraic Cache 452 according to an example embodiment. Other embodiments may use a different data set information store to store information regarding the data sets or a different relation store to store information regarding algebraic relations known to the system.

As shown in FIG. 4B, the Set Universe 450 may maintain a list of GUIDs for the data sets known to the system. Each GUID is a unique identifier for a data set in the system. The Set Universe 450 may also associate information about the particular data set with each GUID. This information may include, for example, an external identifier used to refer to the data set (which may or may not be unique to the particular data set) in statements provided through the connectors, a date/time indicator to indicate the time that the data set became known to the system, a format field to indicate the format of the data set, and a set type with flags to indicate the type of the data set. The format field may indicate a logical to physical translation model for the data set in the system. For example, the same logical data is capable of being stored in different physical formats on storage media in the system. As used herein, the physical format refers to the format for encoding the logical data when it is stored on storage media and not to the particular type of physical storage media (e.g., disk, RAM, flash memory, etc.) that is used. The format field indicates how the logical data is mapped to the physical format on the storage media. For example, a data set may be stored on storage media in comma separated value (CSV) format, binary-string encoding (BSTR) format, fixed-offset (FIXED) format, type-encoded data (TED) format and/or markup language format. Type-encoded data (TED) is a file format that contains data and an associated value that indicates the format of such data. These are examples only and other physical formats may be used in other embodiments. While the Set Universe stores information about the data sets, the underlying data may be stored elsewhere in this example embodiment, such as Storage 124 in FIG. 1, Network Attached Storage 204a, b and c in FIG. 2, Memory 308a-f in FIG. 3 or other storage. Some data sets may not exist in physical storage, but may be calculated from algebraic relations known to the system. In some cases, data sets may even be defined by algebraic relations referencing data sets that have not yet been provided to the system and cannot be calculated until those data sets are provided at some future time. The set type may indicate whether the data set is available in storage, referred to as realized, or whether it is defined by algebraic relations with other data sets, referred to as virtual. Other types may also be supported in some embodiments, such as a transitional type to indicate a data set that is in the process of being created or removed from the system. These are examples only and other information about data sets may also be stored in a data set information store in other embodiments.

As shown in FIG. 4B, the Algebraic Cache 452 may maintain a list of algebraic relations relating one data set to another. In the example shown in FIG. 4B, an algebraic relation may specify that a data set is equal to an operation or function performed on one to three other data sets (indicated as “guid OP guid guid guid” in FIG. 4B). Example operations and functions include a composition function, cross union function, superstriction function, projection function, inversion function, cardinality function, join function and restrict function. An algebraic relation may also specify that a data set has a particular relation to another data set (indicated as “guid REL guid” in FIG. 4B). Example relational operators include equal, subset and disjoint as well as their negations, as further described at the end of this specification as part of the Example Extended Set Notation. These are examples only and other operations, functions and relational operators may be used in other embodiments, including functions that operate on more than three data sets.

The Set Manager 402 may be accessed by other modules to add new GUIDS for data sets and retrieve known relationships between data sets for use in optimizing and evaluating other algebraic relations. For example, the system may receive a query language statement specifying a data set that is the intersection of a first data set A and a second data set B. The resulting data set C may be determined and may be returned by the system. In this example, the modules processing this request may call the Set Manager 402 to obtain known relationships from the Algebraic Cache 452 for data sets A and B that may be useful in evaluating the intersection of data sets A and B. It may be possible to use known relationships to determine the result without actually retrieving the underlying data for data sets A and B from the storage system. The Set Manager 402 may also create a new GUID for data set C and store its relationship in the Algebraic Cache 452 (i.e., data set C is equal to the intersection of data sets A and B). Once this relationship is added to the Algebraic Cache 452, it is available for use in future optimizations and calculations. All data sets and algebraic relations may be maintained in the Set Manager 402 to provide temporal invariance. The existing data sets and algebraic relations are not deleted or altered as new statements are received by the system. Instead, new data sets and algebraic relations are composed and added to the Set Manager 402 as new statements are received. For example, if data is requested to be removed from a data set, a new GUID can be added to the Set Universe and defined in the Algebraic Cache 452 as the difference of the original data set and the data to be removed.

The Optimizer 418 receives algebraic expressions from the Model Interface 416 and optimizes them for calculation. When a data set needs to be calculated (e.g., for purposes of realizing it in the storage system or returning it in response to a request from a user), the Optimizer 418 retrieves an algebraic relation from the Algebraic Cache 452 that defines the data set. The Optimizer 418 can then generate a plurality of collections of other algebraic relations that define an equivalent data set. Algebraic substitutions may be made using other algebraic relations from the Algebraic Cache 452 and algebraic operations may be used to generate relations that are algebraically equivalent. In one example embodiment, all possible collections of algebraic relations are generated from the information in the Algebraic Cache 452 that define a data set equal to the specified data set.

The Optimizer 418 may then determine an estimated cost for calculating the data set from each of the collections of algebraic relations. The cost may be determined by applying a costing function to each collection of algebraic relations, and the lowest cost collection of algebraic relations may be used to calculate the specified data set. In one example embodiment, the costing function determines an estimate of the time required to retrieve the data sets from storage that are required to calculate each collection of algebraic relations and to store the results to storage. If the same data set is referenced more than once in a collection of algebraic relations, the cost for retrieving the data set may be allocated only once since it will be available in memory after it is retrieved the first time. In this example, the collection of algebraic relations requiring the lowest data transfer time is selected for calculating the requested data set.

The Optimizer 418 may generate different collections of algebraic relations that refer to the same logical data stored in different physical locations over different data channels and/or in different physical formats. While the data may be logically the same, different data sets with different GUIDs may be used to distinguish between the same logical data in different locations or formats. The different collections of algebraic relations may have different costs, because it may take a different amount of time to retrieve the data sets from different locations and/or in different formats. For example, the same logical data may be available over the same data channel but in a different format. Example formats may include comma separated value (CSV) format, binary-string encoding (BSTR) format, fixed-offset (FIXED) format, type-encoded data (TED) format and markup language format. Other formats may also be used. If the data channel is the same, the physical format with the smallest size (and therefore the fewest number of bytes to transfer from storage) may be selected. For instance, a comma separated value (CSV) format is often smaller than a fixed-offset (FIXED) format. However, if the larger format is available over a higher speed data channel, it may be selected over a smaller format. In particular, a larger format available in a high speed, volatile memory such as a DRAM would generally be selected over a smaller format available on lower speed non-volatile storage such as a disk drive or flash memory.

In this way, the Optimizer 418 takes advantage of high processor speeds to optimize algebraic relations without accessing the underlying data for the data sets from data storage. Processor speeds for executing instructions are often higher than data access speeds from storage. By optimizing the algebraic relations before they are calculated, unnecessary data access from storage can be avoided. The Optimizer 418 can consider a large number of equivalent algebraic relations and optimization techniques at processor speeds and take into account the efficiency of data accesses that will be required to actually evaluate the expression. For instance, the system may receive a query requesting data that is the intersection of data sets A, B and D. The Optimizer 418 can obtain known relationships regarding these data sets from the Set Manager 402 and optimize the expression before it is evaluated. For example, it may obtain an existing relation from the Algebraic Cache 452 indicating that data set C is equal to the intersection of data sets A and B. Instead of calculating the intersection of data sets A, B and D, the Optimizer 418 may determine that it would be more efficient to calculate the intersection of data sets C and D to obtain the equivalent result. In making this determination, the Optimizer 418 may consider that data set C is smaller than data sets A and B and would be faster to obtain from storage or may consider that data set C had been used in a recent operation and has already been loaded into higher speed memory or cache.

The Optimizer 418 may also continually enrich the information in the Set Manager 402 via submissions of additional relations and sets discovered through analysis of the sets and Algebraic Cache 452. This process is called comprehensive optimization. For instance, the Optimizer 418 may take advantage of unused processor cycles to analyze relations and data sets to add new relations to the Algebraic Cache 452 and sets to the Set Universe that are expected to be useful in optimizing the evaluation of future requests. Once the relations have been entered into the Algebraic Cache 452, even if the calculations being performed by the Set Processor 404 are not complete, the Optimizer 418 can make use of them while processing subsequent statements. There are numerous algorithms for comprehensive optimization that may be useful. These algorithms may be based on the discovery of repeated calculations on a limited number of sets that indicate a pattern or trend of usage emerging over a recent period of time.

The Set Processor 404 actually calculates the selected collection of algebraic relations after optimization. The Set Processor 404 provides the arithmetic and logical processing required to realize data sets specified in algebraic extended set expressions. In an example embodiment, the Set Processor 404 provides a collection of functions that can be used to calculate the operations and functions referenced in the algebraic relations. The collection of functions may include functions configured to receive data sets in a particular physical format. In this example, the Set Processor 404 may provide multiple different algebraically equivalent functions that operate on data sets and provide results in different physical formats. The functions that are selected for calculating the algebraic relations correspond to the format of the data sets referenced in those algebraic relations (as may be selected during optimization by the Optimizer 418). In example embodiments, the Set Processor 404 is capable of parallel processing of multiple simultaneous operations, and, via the Storage Manager 420, allows for pipelining of data input and output to minimize the total amount of data that is required to cross the persistent/volatile storage boundary. In particular, the algebraic relations from the selected collection may be allocated to various processing resources for parallel processing. These processing resources may include processor 102 and accelerator 122 shown in FIG. 1, distributed computer systems as shown in FIG. 2, multiple processors 302 and MAPs 306 as shown in FIG. 3, or multiple threads of execution on any of the foregoing. These are examples only and other processing resources may be used in other embodiments.

The Executive 422 performs overall scheduling of execution, management and allocation of computing resources, and proper startup and shutdown.

Administrator Interface 424 provides an interface for managing the system. In example embodiments, this may include an interface for importing or exporting data sets. While data sets may be added through the connectors, the Administrator Interface 424 provides an alternative mechanism for importing a large number of data sets or data sets of very large size. Data sets may be imported by specifying the location of the data sets through the interface. The Set Manager 402 may then assign a GUID to the data set. However, the underlying data does not need to be accessed until a request is received that requires the data to be accessed. This allows for a very quick initialization of the system without requiring data to be imported and reformatted into a particular structure. Rather, relationships between data sets are defined and added to the Algebraic Cache 452 in the Set Manager 402 as the data is actually queried. As a result, optimizations are based on the actual way the data is used (as opposed to predefined relationships built into a set of tables or other predefined data structures).

Example embodiments may be used to manage large quantities of data. For instance, the data store may include more than a terabyte, one hundred terabytes or a petabyte of data or more. The data store may be provided by a storage array or distributed storage system with a large storage capacity. The data set information store may, in turn, define a large number of data sets. In some cases, there may be more than a million, ten million or more data sets defined in the data information store. In one example embodiment, the software may scale to 2⁶⁴ data sets, although other embodiments may manage a smaller or larger universe of data sets. Many of these data sets may be virtual and others may be realized in the data store. The entries in the data set information store may be scanned from time to time to determine whether additional data sets should be virtualized or whether to remove data sets to temporally redefine the data sets captured in the data set information store. The relation store may also include a large number of algebraic relations between data sets. In some cases, there may be more than a million, ten million or more algebraic relations included in the relation store. In some cases, the number of algebraic relations may be greater than the number of data sets. The large number of data sets and algebraic relations represent a vast quantity of information that can be captured about the data sets in the data store and allow processing and algebraic optimization to be used to efficiently manage extremely large amounts of data. The above are examples only and other embodiments may manage a different number of data sets and algebraic relations.

Most data management systems may be based on malleable data sets. That is, when an insertion or deletion occurs the data set may be modified. An alternative approach may be to use immutable data sets. That is, when an insertion or deletion occurs, the original data set may be untouched and a new data set may be created that is the result of the insertion or deletion. The immutable data set approach may be used in A2DB and SPARQL Server because in the immutable data set approach it may be easy to maintain an expression universe where the expressions are never invalidated by mutations to their constituent data sets. With immutable data sets, as more queries are run, the Algebraic Cache 452 becomes richer and richer, and the probability of encountering reusable expressions grows. This may be advantageous because it permits the substitution of an already calculated (enumerated) data set for one that has yet to be calculated (enumerated), thereby avoiding computation. However, the usefulness of this rich universe of expressions becomes diminished due to insertions and deletions.

Restriction promotion/demotion optimizations may assume that the data is constant and the query varies. As such, the query optimization attempts to push restrictions down toward the leaf nodes to eliminate as much data as fast as possible and the global optimization attempts to pull the restriction as high as possible toward the root node to make invariant as much of the computation as possible. In contrast insertions, deletions, and streaming queries cause the data to change, and especially in the case of streaming queries, the query becomes the invariant part.

Data sets may be stored in a database and accessed via database queries. There are a number of different implementations of databases and query languages, such as Structured Query Language (SQL) and the SPARQL Protocol and RDF Query Language (SPARQL). A database as used herein may include SQL or SQL-based databases, non-SQL databases, or any other type of data management system. A user of a computing device or an application executing on the application may use the query language to query the database for information. Queries may be handled sequentially—that is, queries may be processed one at a time in the order in which they are received by the database. However, sequential querying of a large database may consume computing resources take a long time. In addition, multiple queries may make use of one or more common sub-sections, or sub-graphs, of the database.

Systems and methods disclosed herein allow the use of algebra to optimize several queries at once by algebraically breaking them into pieces, finding common sub-expressions, finding patterns of similar expressions and triggering comprehensive optimizations prior to query execution, and ordering all the operations for most efficient processing.

For example, a database may store information about various publications and a user or application may make the following database query, shown below as a SPARQL query:

```
SELECT ?yr
WHERE {
      ?journal rdf:type bench:Journal .
      ?journal dc:title “Journal 1 (1940)”\hat{ }\hat{ }xsd:string .
      ?journal dcterms:issued ?yr
}
```

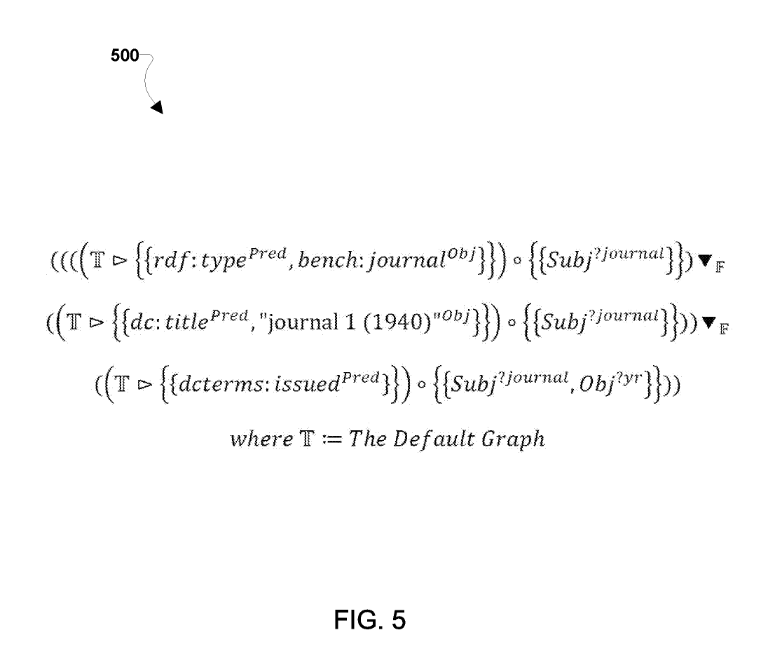

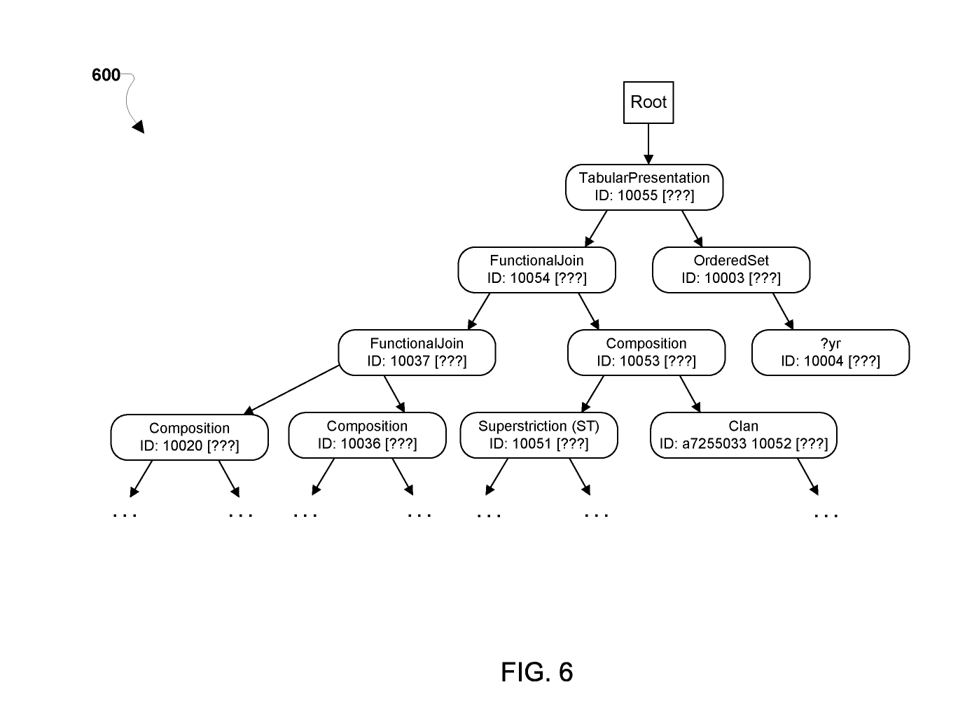

The SPARQL query searches for journal titles that match the string “Journal 1 (1940)”. The query returns the year of database entries that satisfy the query. FIG. 5 illustrates a mathematical expression 500 that is equivalent to the database query shown above. FIG. 6 illustrates a query graph 600 that represents a portion of the mathematical expression 500. A query graph may be generated for each query, in which the nodes represent records, data sets, or data, and edges represent relationships between nodes.

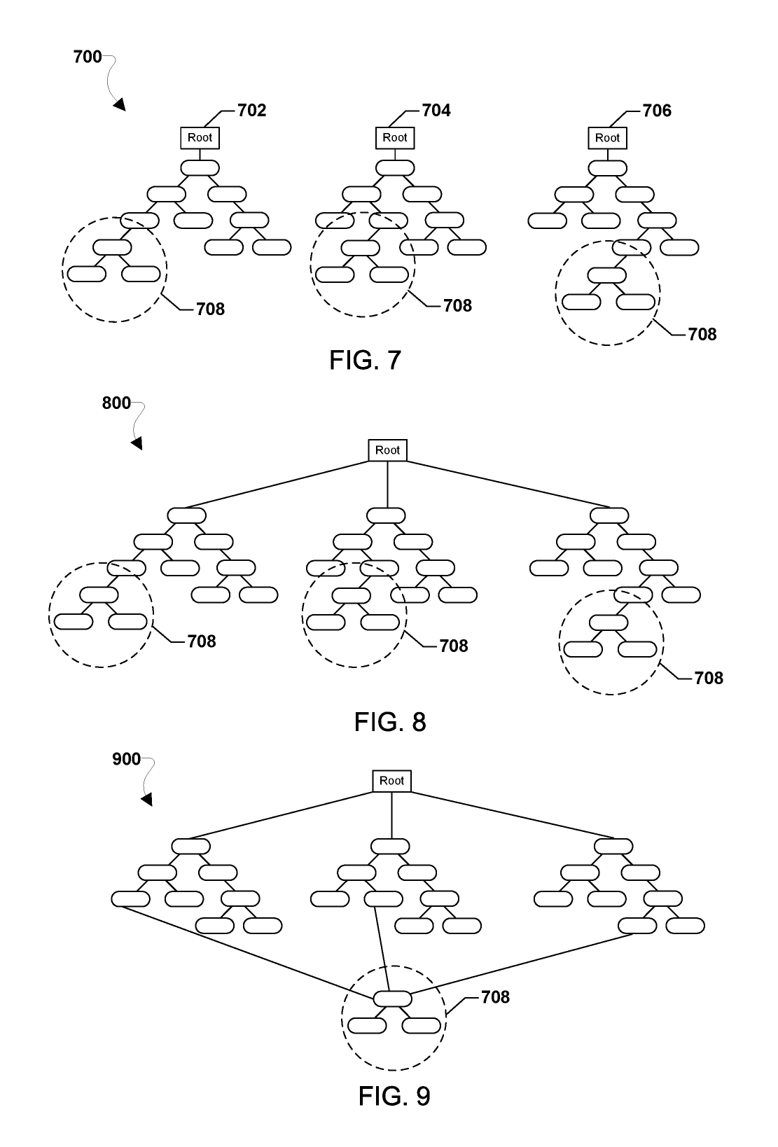

Given a batch of queries on the same database, there may be common sub-expressions, nodes, or sub-graphs in the query graph between two or more of the queries. When such commonalities are identified, optimizations may be performed on the batch of queries in order to yield one or more execution plans that may process the batch of queries more efficiently than if they were considered separately or in series. FIG. 7 illustrates examples of abstracted query graphs 702, 704, and 706 that represent three separate database queries (not necessarily representing the query described above). Although each query graph 702, 704, and 706 may represent different queries, there may be common patterns among two or more of the query graphs. For example, each query graph 702, 704, and 706 may contain a common sub-expression 708. If the computing device processes each query sequentially, the computing device may create and navigate each query graph 702, 704, and 706 separately.

However, if the query graphs 702, 704, and 706 are batched and analyzed together, optimizations may be applied to the batched query graphs 702, 704, and 706 based on the common sub-expression 708. Thus execution plans may be constructed that instruct the computing device to processes the query graphs 702, 704, and 706 simultaneously, in a beneficial order that differs from what the user submitted and may include interleaving query evaluation, and/or by sharing intermediary results or adaptive restructuring data structures in such a way that the computing device may be able to obtain the query results quicker and utilize fewer computing resources (e.g., processor time, memory) than if the queries were considered by the optimizer separately or in series.

FIG. 8 illustrates an example of an abstracted combined query graph 800 that is the combination of query graphs 702, 704, and 706 under a single root node. Combining all the queries under a single root node may allow the computing device to treat single or multiple queries uniformly. The computing device may also apply optimizations to the combined query graph 800 in the same way that optimizations may be applied to the individual query graphs 702, 704, and 706 without any modifications.

FIG. 9 illustrates an abstracted combined query graph 900 that represents a multi-query optimization that includes reusing the already-identified common sub-expression 708 across the individual queries. Reusing common sub-expressions is one example of a number of optimizations that may be performed on the combined query graph 900. Other examples of multi-query optimizations may include restriction promotion, group-restrict inversion, partitioning, and other forms of adaptive data restructuring. Some additional multi-query optimizations are disclosed in co-pending U.S. patent application Ser. No. 15/218,400, entitled “Structural Equivalence,” and U.S. patent application Ser. No. 15/222,103, entitled “Maintaining Performance in the Presence of Insertions, Deletions, and Streaming Queries,” each of which is incorporated by reference herein in its entirety. Individual queries on the same database may be related, such as sharing particular query terms or sub-expressions, relevant rows or columns, and relevant sub-graphs or sub-sections of the database. Thus the computing device may take advantage of these relationships and identify efficiencies when combining the queries together in order to produce an optimized combined query.

In another example of multi-query optimization, the computing device may receive and serially evaluate queries q₀, qₖ, . . . , qₙ. The computing device may determine that adaptive restructuring (e.g. building a precomputed group cube) should be applied based on the evidence gathered by analyzing queries [q₀, . . . , qₖ]. However, if the subsequent queries (qₖ, . . . , q_{j≦n}] were evaluated as well, the computing device may determine that the group cube formulation should be based on a more or less granular pre-aggregation partitioning However, because the queries were serially evaluated the initial group cube has already been instantiated. Recalculating the group cube may incur additional time and resource costs such that it is not worthwhile to redo the processing of the queries from the beginning Thus the computing device may continue to utilize the sub-optimal group cube to process the remaining queries even though a more optimal group cube could have been formulated if the queries were batched and analyzed together. By utilizing the multi-query approach to analyzing a batch of queries concurrently, the optimal adaptive restructuring step can be performed at an earlier beneficial stage of the resulting execution plan, and the sub-optimal optimization actions would be avoided.

More generally, multi-query optimizations may be determined by introducing the concept of pre-prediction confidence into the optimization model. The optimization model may weigh certain quantities (e.g. predicted utility, actual usage, predicted usage) in a multi-query optimization differently than it could in a serialized fashion because more information is available (i.e., more queries to analyze). As pre-prediction confidence goes up, the numerical features of the model may change correspondingly, and the adaptive restructuring algorithm may produce results that are possibly different and of higher quality than in the serialized case. The pre-prediction confidence can be parameterized and affected by both local and global clustering coefficients of the combined query graph. The pre-prediction confidence can additionally be parameterized by increasing the confidence proportionate to the number of (uncombined) expressions (such as the original user-submitted queries) to which a node in the combined multi-query expression relates.

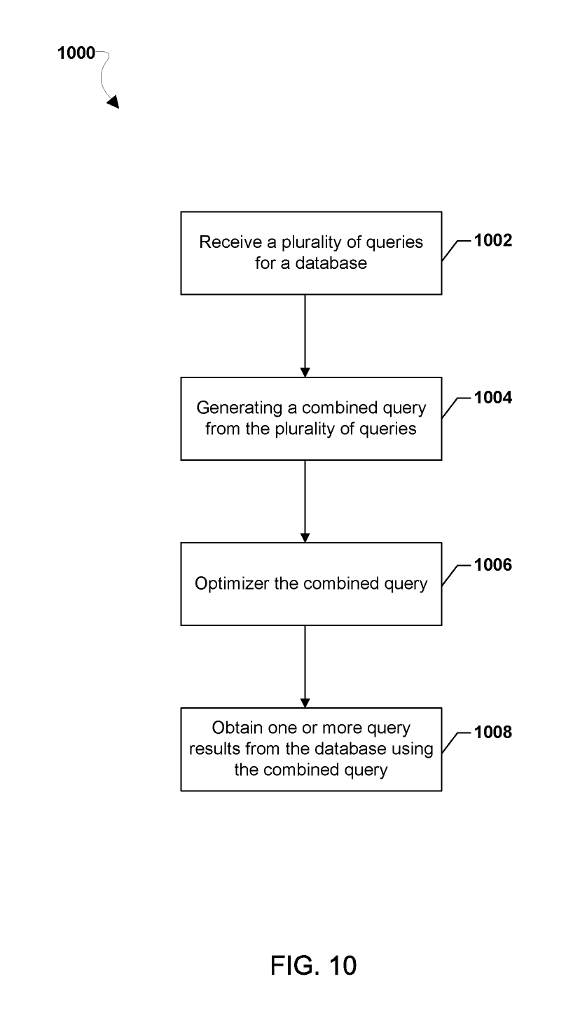

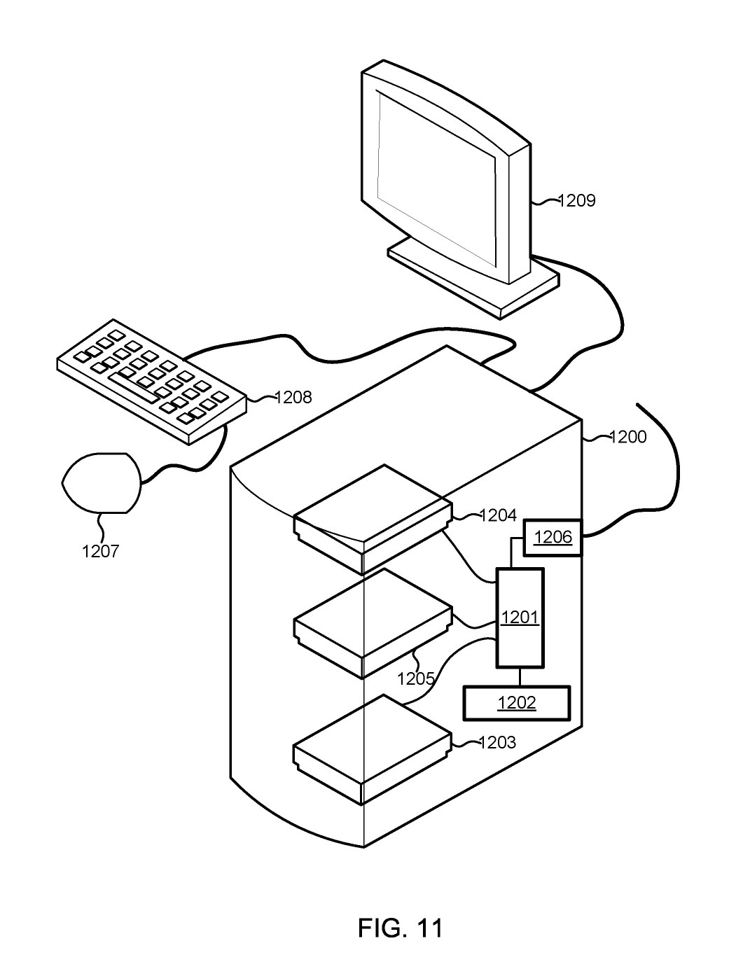

FIG. 10 illustrates a method 1000 for implementing multi-query optimization on a computing device. The method 1000 may be performed by a processor on a computing device that stores or has access to a database. The computing device may be a desktop computer, laptop, tablet, mobile device, server, or other type of computing device.

In block 1002, the processor may receive a plurality of queries for a database. The queries may be generated by one or more users of the computing device and/or one or more applications executing on the computing device. The queries may be formatted in a database query language such as SQL or SPARQL. The queries may be received over a period of time, and do not have to be received simultaneously or near simultaneously.

In block 1004, the processor may generate a combined query from the plurality of queries. The processor may assimilate queries as they are received and store the combined query in memory like an instruction to be executed. The processor may identify a common root node for the plurality of queries.

In block 1006, the processor may also apply one or more optimizations to the combined query, for example by identifying and reusing common sub-expressions within the plurality of queries. Other examples of multi-query optimizations may include restriction promotion, group-restrict inversion, partitioning, reusing structurally equivalent data sets from prior queries, optimizations of insertions, deletions, and streaming, as well as other forms of adaptive data restructuring. In general, the plurality of queries may contain one or more common nodes, sub-expressions, or sub-graphs among the various queries. The computing device may analyze the plurality of queries to identify the common nodes, sub-expressions, or sub-graphs, and apply optimizations based on the identified common nodes, sub-expressions, or sub-graphs. In some embodiments, the processor may determine a pre-prediction confidence value for the combined query and select an optimization based on the pre-prediction confidence value.

In block 1008, the processor may obtain one or more query results from the database from the combined query. Obtaining the one or more query results from the combined query may be more efficient than obtaining the results from the plurality of queries sequentially. For example, there may be a reduction in the amount of time and/or resources (e.g., processor resources, memory) consumed to obtain the results. The combined query does not have to be executed immediately after receiving the plurality of queries. Rather, the combined query may be executed after certain time intervals or at predetermined points in time. The one or more query results may be returned to the user and/or to the application(s) that generates the plurality of queries. In this mariner, the method 1000 allows for multi-query optimization when processing queries to a database.

The various embodiments may be implemented in any of a variety of computing devices, an example of which is illustrated in FIG. 11. A computing device 1200 will typically include a processor 1201 coupled to volatile memory 1202 and a large capacity nonvolatile memory, such as a disk drive 1205 of Flash memory. The computing device 1200 may also include a floppy disc drive 1203 and a compact disc (CD) drive 1204 coupled to the processor 1204. The computing device 1200 may also include a number of connector ports 1206 coupled to the processor 1201 for establishing data connections or receiving external memory devices, such as a USB or FireWire® connector sockets, or other network connection circuits for establishing network interface connections from the processor 1201 to a network or bus, such as a local area network coupled to other computers and servers, the Internet, the public switched telephone network, and/or a cellular data network. The computing device 1200 may also include the trackball 1207, keyboard 1208 and display 1209 all coupled to the processor 1201.

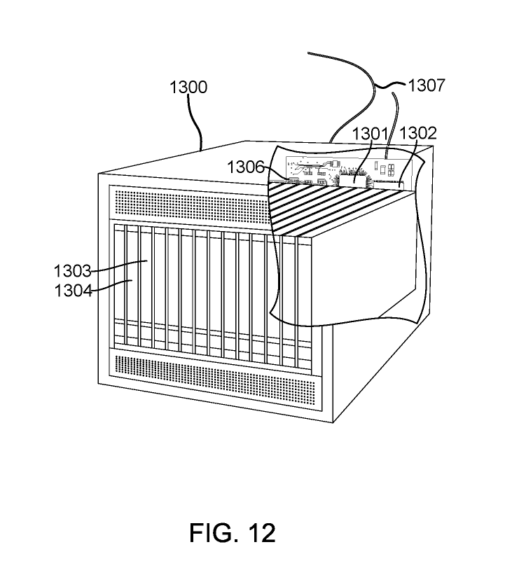

The various embodiments may also be implemented on any of a variety of commercially available server devices, such as the server 1300 illustrated in FIG. 12. Such a server 1300 typically includes a processor 1301 coupled to volatile memory 1302 and a large capacity nonvolatile memory, such as a disk drive 1303. The server 1300 may also include a floppy disc drive, compact disc (CD) or DVD disc drive 1304 coupled to the processor 1301. The server 1300 may also include network access ports 1306 coupled to the processor 1301 for establishing network interface connections with a network 1307, such as a local area network coupled to other computers and servers, the Internet, the public switched telephone network, and/or a cellular data network.

The processors 1201 and 1301 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 1202, 1205, 1302, and 1303 before they are accessed and loaded into the processors 1201 and 1301. The processors 1201 and 1301 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1201 and 1301 including internal memory or removable memory plugged into the device and memory within the processor 1201 and 1301 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for multi-query optimization on a computing device, comprising:
receiving a plurality of queries for a database;
generating a combined query from the plurality of queries;
applying an optimization to the combined query; and
obtaining one or more query results from the database from the combined query.

2. The method of claim 1, wherein the optimization comprises reusing at least one of a common sub-expression of the plurality of queries and a shared pattern of the plurality of queries that would result in adaptive restructuring.

3. The method of claim 1, wherein generating the combined query comprises identifying a common root node of the plurality of queries.

4. The method of claim 1, wherein the plurality of queries are received over a period of time.

5. The method of claim 4, wherein the combined query is generated after the period of time expires.

6. The method of claim 1, wherein applying an optimization to the combined query comprises:
identifying one or more common nodes, sub-expressions, or sub-graphs from the plurality of queries; and
applying the optimization to the one or more common nodes, sub-expressions, or sub-graphs.

7. The method of claim 1, wherein applying the optimization to the combined query and obtaining the one or more query results from the combined query consumes less time and resources of the computing device than obtaining the one or more query results from the plurality of queries sequentially.

8. The method of claim 1, wherein applying the optimization to the combined query comprises determining a pre-prediction confidence value for the combined query and selecting an optimization based on the pre-prediction confidence value.

9. A computing device, comprising:
a processor configured with processor-executable instructions to perform operations comprising:
receiving a plurality of queries for a database;
generating a combined query from the plurality of queries;
applying an optimization to the combined query; and
obtaining one or more query results from the database from the combined query.

10. The computing device of claim 9, wherein the processor is further configured to perform operations such that applying an optimization to the combined query comprises reusing at least one of a common sub-expression of the plurality of queries and a shared pattern of the plurality of queries that would result in adaptive restructuring.

11. The computing device of claim 9, wherein the processor is further configured to perform operations such that generating the combined query comprises identifying a common root node of the plurality of queries.

12. The computing device of claim 9, wherein the plurality of queries are received over a period of time and the combined query is generated after the period of time expires.

13. The computing device of claim 9, wherein the processor is further configured to perform operations such that applying an optimization to the combined query comprises:
identifying one or more common nodes, sub-expressions, or sub-graphs from the plurality of queries; and
applying the optimization to the one or more common nodes, sub-expressions, or sub-graphs.

14. The computing device of claim 9, wherein applying the optimization to the combined query and obtaining the one or more query results from the combined query consumes less time and resources of the computing device than obtaining the one or more query results from the plurality of queries sequentially.

15. The computing device of claim 9, wherein the processor is further configured to perform operations such that applying the optimization to the combined query comprises determining a pre-prediction confidence value for the combined query and selecting an optimization based on the pre-prediction confidence value.

16. A non-transitory computer readable storage medium having stored thereon processor-executable software instructions configured to cause a processor of a computing device to perform operations comprising:
receiving a plurality of queries for a database;
generating a combined query from the plurality of queries;
applying an optimization to the combined query; and
obtaining one or more query results from the database from the combined query.

17. The non-transitory computer readable storage medium of claim 16, wherein the plurality of queries are received over a period of time and the combined query is generated after the period of time expires.

18. The non-transitory computer readable storage medium of claim 16, wherein the stored processor-executable software instructions are configured to cause the processor to perform operations such that applying an optimization to the combined query comprises:
identifying one or more common nodes, sub-expressions, or sub-graphs from the plurality of queries; and
applying the optimization to the one or more common nodes, sub-expressions, or sub-graphs.

19. The non-transitory computer readable storage medium of claim 16, wherein applying the optimization to the combined query and obtaining the one or more query results from the combined query consumes less time and resources of the computing device than obtaining the one or more query results from the plurality of queries sequentially.

20. The non-transitory computer readable storage medium of claim 16, wherein the stored processor-executable software instructions are configured to cause the processor to perform operations such that applying the optimization to the combined query comprises:
determining a pre-prediction confidence value for the combined query and selecting an optimization based on the pre-prediction confidence value.
